(19) United States
(12) Patent Application Publication
(10) Pub. No.: US 2017/0254351 A1
(43) Pub. Date: Sep. 7, 2017

(54) ANTI-ROTATION DEVICE AND ASSEMBLY

(71) Applicant: Cummins Ltd, Huddersfield (GB)

(72) Inventor: Steven C. Rooks, Honley, Holmfirth, West Yorkshire (GB)

(73) Assignee: Cummins Ltd, Huddersfield (GB)

(21) Appl. No.: 15/528,480

(22) PCT Filed: Nov. 20, 2015
(86) PCT No.: PCT/GB2015/053554

§ 371 Date: May 19, 2017

(30) Foreign Application Priority Data
Nov. 20, 2014 (GB) 1420626.2

(51) Int. Cl. F16B 21/18

(52) U.S. Cl. CPC F16B 21/183

(57) ABSTRACT

A assembly comprises: a first member, a second member and an anti-rotation device. The first member is provided with a bore and a groove on a surface of the bore. At least a portion of the second member is disposed within the bore in the first member and a recess is provided on a generally axially facing surface of the portion of the second member. The anti-rotation device comprises an arcuate resilient body comprising a radially inner portion and a radially outer portion, the radially outer portion being received within the groove, the radially inner portion abutting a surface of the portion of the second member. A first anti-rotation feature is provided on the radially outer portion for cooperation with a complimentary feature of the first member. A second anti-rotation feature is provided on the radially inner portion, extending away from the radially inner portion of the body in a generally axial direction and is received within the recess on the second member.

### FIELD OF THE DISCLOSURE

The present disclosure relates to an anti-rotation device that is arranged to cooperate with two adjacent elements so as to prevent relative rotation of the two elements.

In particular, it may relate to a bearing unit comprising a bearing housing, a bearing assembly and an anti-rotation device that is arranged to prevent the bearing assembly from rotating relative to the bearing housing. The bearing unit may form part of a turbomachine such as a turbocharger or an expansion turbine of a waste heat recovery system.

Alternatively, it may relate to a compressor housing comprising two members that cooperate to form a housing for a compressor wheel and an anti-rotation device that is arranged to prevent relative rotation of the two members. The compressor housing and compressor wheel may together form the compressor of a turbocharger. The two members of the compressor housing may comprise a bearing housing and a compressor cover respectively.

In general, a turbomachine comprises a rotor which is housed within a housing or cast and which is arranged to transfer energy to, or receive energy from, a fluid within the housing. The rotor is connected to a shaft, which is supported by a bearing assembly, allowing the shaft and rotor to rotate within the housing. For example, the bearing assembly may comprise a rolling element bearing, with an inner race, an outer race and a number of rolling elements disposed therebetween. The shaft is received within a bore in the inner race of the bearing assembly. The bearing assembly is received by a bore in a bearing housing, an inner radial dimension of the bore being generally the same as an outer radial dimension of the outer race of the bearing assembly.

### BACKGROUND OF THE DISCLOSURE

A waste heat recovery system may be used to recover heat from an engine assembly and convert the recovered heat into usable power. Power derived from the waste heat recovery system may be used to generate electricity and/or to augment power output from the internal combustion engine. A conventional waste heat recovery system uses a refrigerant fluid which is pumped around a closed loop. A heat exchanger is used to transfer heat from parts of the engine assembly to the refrigerant, which is initially in liquid form, causing the refrigerant to vaporise. The refrigerant vapour passes to an expansion turbine and drives a turbine wheel of the expansion turbine to rotate. The turbine wheel is mounted on a shaft which is supported for rotation by a bearing unit. The bearing unit may, for example, comprise a rolling element bearing assembly disposed in a bore in a central bearing housing. Power is derived from the rotation of the turbine wheel. The refrigerant vapour passes from the expansion turbine to a condenser which is configured to cool and condense the refrigerant so that it returns to liquid form. The refrigerant liquid is then passed to the heat exchanger, where the heat recovery cycle begins again.

Turbochargers are well known devices for supplying air to the intake of an internal combustion engine at pressures above atmospheric pressure (boost pressures). A conventional turbocharger comprises an exhaust gas driven turbine wheel mounted on a rotatable shaft within a turbine housing. Rotation of the turbine wheel rotates a compressor wheel mounted on the other end of the shaft within a compressor housing. The compressor wheel delivers compressed air to the intake manifold of the engine, thereby increasing engine power. The turbocharger shaft may be supported for rotation by a rolling element bearing assembly disposed in a bore in a central bearing housing. The bearing housing is connected between the turbine and compressor wheel housings.

In such turbomachines, it may be desirable to prevent the bearing assembly from rotating relative to the bearing housing. For example, for turbomachines that use rolling element bearing assemblies, it may be desirable to prevent the outer race of the bearing assembly from rotating relative to the bearing housing. This may be achieved using an anti-rotation device that engages with both the outer race of the bearing assembly and the bearing housing.

One conventional anti-rotation device for this purpose comprises a pin which extends through a radial opening in the bearing housing and a radial opening in the outer race of the bearing assembly. Such an arrangement is difficult to assemble since it requires accurate machining and subsequent alignment of the radial openings in the bearing housing and the outer race of the bearing assembly for insertion of the pin.

Another conventional anti-rotation device comprises a ring which is disposed between the bearing housing and the outer race of the bearing assembly. The ring comprises an outer portion that extends radially into an annular groove in the bearing housing and an inner portion that extends radially into an annular groove in the outer race of the bearing housing. The outer portion is provided with an anti-rotation feature that cooperates with a complimentary feature in the bearing housing and the inner portion is provided with an anti-rotation feature that cooperates with a complimentary feature in the bearing assembly. However, it is challenging to assemble such an arrangement, wherein the inner and outer portions both extend radially into their corresponding grooves.

### SUMMARY

A first method for assembly of such an arrangement requires the bearing housing to be formed in two parts such that the groove that receives the outer portion of the anti-rotation device is formed by the intersection of the two parts. First the anti-rotation device is distorted radially outwards, placed around the bearing assembly and then allowed to snap back so that the inner portion of an anti-rotation device is received in a groove on the bearing assembly. Next, the anti-rotation device and bearing assembly are inserted together into a bore in a first portion of the bearing housing and, subsequently, a second portion of the bearing housing is attached to the first portion.

A second method for assembly of such an arrangement requires the radial depth of the groove in the bearing assembly to be larger than the radial extent of the outer portion of the anti-rotation device. First the anti-rotation device is distorted radially inwards, inserted into the bearing housing and then allowed to snap back so that the outer portion is received in the bearing housing. Next, the anti-rotation device is distorted radially outwards into the oversized groove in the bearing housing and the bearing assembly is inserted together into a bore in the bearing housing. Once the bearing assembly is in place the anti-rotation device is allowed to snap back so that the inner portion of an anti-rotation device is received in a groove on the bearing assembly.

To aid assembly of a turbocharger, the compressor housing that houses the compressor wheel may comprise two members that cooperate to form a housing. For example, the compressor housing may be formed by cooperation of a central bearing housing and a compressor cover. To assemble the compressor housing, the two members are brought into cooperation with the compressor wheel in situ. With such an arrangement, it may be desirable to prevent the compressor cover from rotating relative to the bearing housing. This may be achieved using an anti-rotation device that engages with both the compressor cover and the bearing housing. For example, it is conventional to use one or more pins or bolts to prevent relative rotation of the compressor cover and the bearing housing.

It is an object of the embodiments of the present disclosure to provide an anti-rotation device that at least partially addresses one or more problems or disadvantages present in the prior art, whether identified herein or elsewhere.

According to a first aspect of the present disclosure, there is provided an assembly comprising: a first member provided with a bore and a groove on a surface of the bore; a second member, at least a portion of the second member being disposed within the bore in the first member, a recess being provided on a generally axially facing surface of said portion of the second member; and an anti-rotation device comprising: an arcuate resilient body comprising a radially inner portion and a radially outer portion, the radially outer portion being received within the groove, the radially inner portion abutting a surface of said portion of the second member; a first anti-rotation feature provided on the radially outer portion for cooperation with a complimentary feature of the first member; and a second anti-rotation feature provided on the radially inner portion extending away from the radially inner portion of the body in a generally axial direction and being received within the recess on the second member.

The first anti-rotation feature prevents mutual rotation of the anti-rotation device and the first member and the second anti-rotation feature prevents mutual rotation of the anti-rotation device and the second member. Therefore the anti-rotation device rotationally locks the first member and the second member together, preventing rotation of one relative to the other.

Since the second anti-rotation feature extends away from the radially inner portion of the body in a generally axial direction, the first aspect provides an assembly that is particularly simple to assemble. In particular, it does not require alignment of two openings for insertion of a pin through a first member and a second member. Further, the anti-rotation device does not extend radially into two opposed grooves (in the first and second members).

To assemble the assembly, first at least a portion of the second member (for example a rolling element bearing assembly) is inserted into a bore of the first member (for example a bearing housing). Next, a compression force is applied to the arcuate resilient body of the anti-rotation device, which is inserted into the bore while compressed. If necessary, the first member and second member are rotated until the first anti-rotation feature is aligned with the complimentary feature of the first member and the second anti-rotation feature is aligned with the recess in the axially facing surface of the second member. The anti-rotation device is inserted further into the bore until the second anti-rotation feature is received within said recess. Finally, the compression force is removed from the anti-rotation device such that it expands so that the radially outer portion of the arcuate resilient body is received within the groove and the first anti-rotation feature cooperates with the complimentary feature of the first member.

The first anti-rotation device may comprise a protrusion. The protrusion may extend axially outwards from the radially outer portion. Alternatively, the protrusion may extend radially outwards from a radially facing surface of the radially outer portion. Alternatively, the first anti-rotation device may be provided by a non-circular shape of a radially outer surface of the radially outer portion.

The first and second anti-rotation devices may form two different parts of a single protrusion from the arcuate body. That is, the first anti-rotation device may be integral with the second anti-rotation device. Said single protrusion may extend in a generally axial direction from the arcuate body.

The first and second anti-rotation features may be disposed at substantially the same position along the arcuate body. For example, for embodiments wherein the arcuate body is generally of the shape of a major sector of an annulus, the first and second anti-rotation features may be disposed at substantially the same circumferential position along the arcuate body. This limits the relative movement of the first and second anti-rotation features when the body is distorted. This may enable for easier alignment of each anti-rotation feature with its corresponding complimentary feature or recess.

Additionally or alternatively, the first and second anti-rotation features may be disposed at a position along the arcuate body that is proximate to one end of the arcuate body. This may correspond to a position along the arcuate body where distortion of the body is minimal. This limits the relative movement of the first and second anti-rotation features when the body is distorted. This may enable for easier alignment of each anti-rotation feature with its corresponding complimentary feature or recess.

The arcuate resilient body may be generally planar and may lie substantially within a plane. An axial direction may refer to a direction that is substantially normal to the plane. The body is a three dimensional object and will have a non-zero extent in the axial direction. However, for a generally planar body lying substantially within the plane, a dimension of the body in the axial direction is small relative to other dimensions of the body.

Within the plane, the resilient body may curve around a central point or axis. A radial direction may refer to a direction within the plane of the body that passes through the central point or axis. When not under tension, the body may be generally of the form of a major sector of an annulus. That is, the body may be of the form of an annulus with a relatively small circumferential gap. Such a shape, which is generally the shape of a circlip or snap-ring, allows the body to distort radially inwards or outwards by application of an appropriate tensioning force.

The arcuate resilient body may be provided with a generally axially facing surface and the second anti-rotation feature may extend from the generally axially facing surface.

A generally axially facing surface is one whose normal is in a generally axial direction. A radially inner portion of the generally axially facing surface may be complimentary to a generally axially facing surface on the second member. At least a portion of the generally axial surface may be flat.

The first and/or second anti-rotation features may be separately formed from the arcuate body and may be attached thereto using any suitable mechanism. Said mechanism may include welding, adhesion and/or braising. For example, in one embodiment, the arcuate body is substantially planar and the first and second anti-rotation devices are formed from a single protrusion, which is attached to an axially facing surface of said body.

Alternatively, the first and/or second anti-rotation features may be integrally formed with the arcuate body. For example, the anti-rotation device may be formed from a single generally flat and planar object. The first and/or second anti-rotation features may be formed by bending a section of said generally flat and planar object such that it extends in a generally axial direction.

The anti-rotation device may further comprise one or more gripping features provided on the body to aid griping of the arcuate body so that a compression force may be applied to it. Two gripping features may be provided. The two gripping features may be provided at opposite ends of the body. The gripping features may be arranged to engage with a gripping tool such as, for example, pliers. The gripping features may comprise flanges, which may extend axially away from the body. Alternatively, the gripping features may comprise apertures.

For embodiments wherein the gripping features comprise flanges that extend axially away from the body, they may either be formed separately from, or integrally with, the arcuate body. If formed separately, the gripping features may be attached to the body using any suitable mechanism such as, for example, welding, adhesion and/or braising. If formed integrally with the arcuate body, the anti-rotation device may be formed from a single generally flat and planar object. The gripping features may be formed by bending a section of said generally flat and planar object such that it extends in a generally axial direction.

The axially extending second anti-rotation feature and one of the gripping features may formed together. For example, the anti-rotation device may be formed from a single generally flat and planar object and the axially extending second anti-rotation device and one of the gripping features may be formed together by bending a single section of said generally flat and planar object twice such that a first portion of it extends axial in one direction (to form the second anti-rotation device) and a second portion of it extends axial in the other direction (to form one of the gripping features).

The assembly may further comprise an end plate. The end plate may engage with the first member to partially cover an open end of the bore in the first member.

The groove may be a generally annular in shape.

The groove may only be open on one generally radially facing side. For such embodiments, the anti-rotation device is axially constrained by the groove once received therein.

Alternatively, the groove may be open on one generally radially facing side and one generally axially facing side. For example, the groove may be formed by a step in the bore. That is, the bore may be a stepped bore comprising two sections of different diameter and the groove may be defined by the step. For such embodiments, the end plate may engage with the first member to form an enclosure (for housing the at least part of the second member) and to close the groove on its open axially facing side.

The bore in the first member may comprise a shoulder formed between a larger diameter section and a smaller diameter section. That is, the bore in the first member may be a stepped bore comprising the larger diameter section and the smaller diameter section. The larger diameter section may be for receipt of the portion of the second member. The smaller diameter section may be for receipt of a shaft. The shaft may be supported by the second member. The shoulder may be generally annular in shape. An axially facing surface of the portion of the second member may abut the shoulder. The second member may be axially constrained relative to the first member by: the shoulder at one end and the anti-rotation device at another end.

In one embodiment, the assembly is a bearing unit, the first member is a bearing housing and the second member is a bearing assembly. The bearing assembly may be a rolling element bearing assembly comprising: an inner race, an outer race and a plurality of rolling elements disposed therebetween. For such embodiments, the recess on the generally axially facing surface of the second member may be provided on the outer race.

For embodiments wherein the assembly is a bearing unit, the first member is a bearing housing and the second member is a bearing assembly, the whole of the second member (i.e. the bearing assembly) may be disposed within the bore of the first member (i.e. the bearing housing).

In an alternative embodiment the assembly is a compressor housing. For example, the first member may be a compressor cover and the second member may be a bearing housing.

For embodiments wherein the assembly is a compressor housing, it may be that only a portion of the second member (i.e. the bearing housing) is disposed within the bore of the first member (i.e. the compressor cover). For example, the bearing housing may comprise a flange and it may be that only the flange of the bearing housing is disposed within the bore of the compressor cover. The flange may be radially outboard of a main body of the bearing housing.

In another alternative embodiment the assembly is a turbine housing. For example, the first member may be a turbine cover and the second member may be a bearing housing.

According to a second aspect of the present disclosure, there is provided an anti-rotation device for use in the assembly of the first aspect.

Such an anti-rotation device is suitable for preventing mutual rotation of first and second members, the first member being provided with a bore within which the second member is received.

The anti-rotation device may comprise: an arcuate resilient body comprising a radially inner portion and a radially outer portion, the radially outer portion being for receipt within a groove in an inner surface of the bore in the first member, the radially inner portion being for abutting a surface of the second member; a first anti-rotation feature provided on the radially outer portion for cooperation with a complimentary feature of the first member; and a second anti-rotation feature provided on wherein the radially inner portion, the second anti-rotation feature extending away from the radially inner portion of the body in a generally axial direction and being for receipt within a recess in an axially facing surface of the second member.

According to a third aspect of the present disclosure, a turbomachine comprising the assembly of the first aspect is provided.

According to a fourth aspect of the present disclosure, an expansion turbine comprising the assembly of the first aspect is provided.

For such embodiments, the assembly forms a bearing unit of the expansion turbine. The first member is a bearing housing and the second member is a bearing assembly. The bearing assembly may be a rolling element bearing assembly comprising: an inner race, an outer race and a plurality of rolling elements disposed therebetween. For such embodiments, the recess on the generally axially facing surface of the second member may be provided on the outer race.

According to a fifth aspect of the present disclosure a turbocharger comprising the assembly of the first aspect is provided.

For such embodiments the assembly may form a compressor housing of the turbocharger. For example, the first member may be a compressor cover and the second member may be a bearing housing. The compressor housing may house a compressor wheel.

According to a sixth aspect of the present disclosure a method of assembling an assembly is provided. The method comprising: providing a first member with a bore and a groove on a surface of the bore; providing a second member, a recess being provided on a generally axially facing surface of the second member; inserting at least a portion of the second member into the bore of the first member; providing an anti-rotation device comprising: an arcuate resilient body, a first anti-rotation feature provided on a radially outer portion of the body, and a second anti-rotation feature provided on a radially inner portion of the body; applying a compression force to the arcuate resilient body of the anti-rotation device; inserting the anti-rotation device into the bore; rotating the anti-rotation device relative to the first member and/or the second member until the first anti-rotation feature is aligned with a complimentary feature of the first member and the second anti-rotation feature is aligned with the recess on the generally axially facing surface of the second member; further inserting the anti-rotation device into the bore until a surface of the anti-rotation device contacts a surface of the second member; and removing the compression force from the anti-rotation device such that it expands so that the radially outer portion of the arcuate resilient body is received within the groove in the bore of the first member; wherein once the assembly is assembled the first anti-rotation feature cooperates with a complimentary feature of the first member, and the second anti-rotation feature is received within the recess on the second member.

It will be appreciated that steps of the method sixth aspect of the present disclosure may be performed in any order as desired or appropriate. For example, the steps of: inserting the anti-rotation device into the bore; and rotating the anti-rotation device relative to the first member and/or the second member may be performed in any order. The first anti-rotation feature may cooperate with the complimentary feature of the first member before or after the compression force is removed from the anti-rotation device. The first anti-rotation feature may cooperate with the complimentary feature of the first member before or after the radially outer portion of the arcuate resilient body is received within the groove in the bore of the first member.

Various aspects and features of the invention set out above or below may be combined with various other aspects and features of the invention as will be readily apparent to the skilled person.

### BRIEF DESCRIPTION OF THE DRAWINGS

Embodiments of the present disclosure will now be described, by way of example only, with reference to the accompanying Figures, of which:

FIG. 1 is a partial cross sectional view of a housing for an expansion turbine including an anti-rotation device according to an embodiment of the present disclosure;

FIG. 2 is a perspective view of the anti-rotation device which forms part of the housing of FIG. 1;

FIG. 3 is an enlarged portion of the housing of FIG. 1;

FIG. 4 is an exploded perspective view of a portion of the housing of FIG. 1;

FIG. 5 shows a partial cross sectional view of a portion of a bearing housing that forms part of the housing of FIG. 1;

FIG. 6 shows the same partial cross sectional view of a portion of a bearing housing as shown in FIG. 5 with a bearing assembly received within a bore in the bearing housing;

FIG. 7 shows the same partial cross sectional view of a portion of the bearing housing and bearing assembly as shown in FIG. 6 in combination with the anti-rotation device of FIG. 2;

FIG. 8 is a cross-sectional view of a turbocharger including an anti-rotation device according to an embodiment of the present disclosure;

FIG. 9 is an enlarged view of a portion of the cross sectional view of the turbocharger shown in FIG. 8;

FIG. 10A is a first perspective view of an anti-rotation device which forms part of the turbocharger of FIG. 8;

FIG. 10B is a second perspective view of an anti-rotation device which forms part of the turbocharger of FIG. 8;

FIG. 11 shows a partial cross sectional view of a portion of a compressor cover that forms part of the turbocharger of FIG. 8;

FIG. 12 shows the same partial cross sectional view of a portion of a compressor cover that forms part of the turbocharger as shown in FIG. 11 with a portion of a bearing housing received within a bore in the compressor cover; and

FIG. 13 shows the same partial cross sectional view of a compressor cover and a bearing housing as shown in FIG. 12 in combination with the anti-rotation device of FIGS. 10A and 10B.

### DETAILED DESCRIPTION

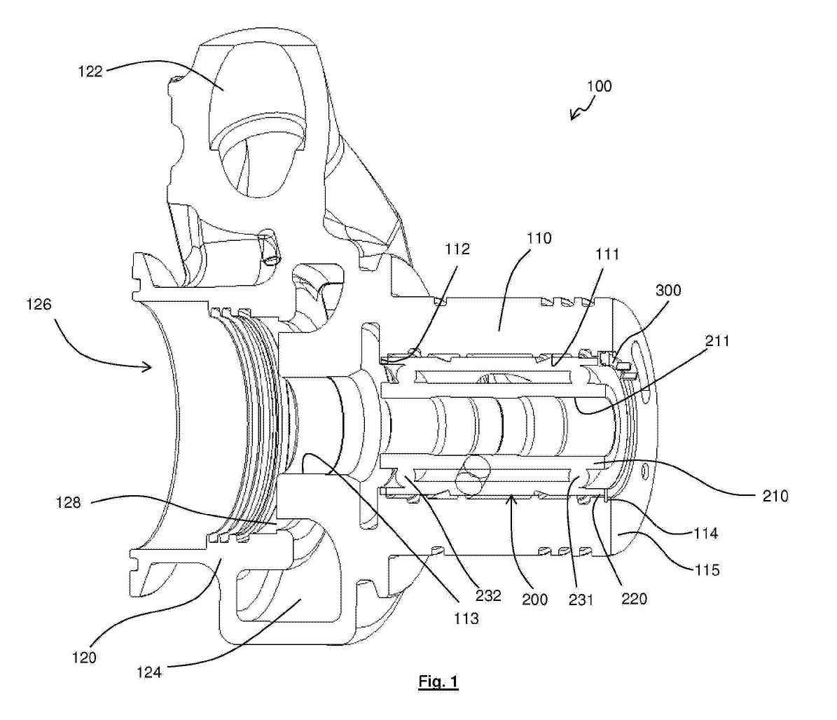

FIG. 1 illustrates a housing 100 for an expansion turbine. The expansion turbine may, for example, form part of an electrical generator. The housing 100 comprises a bearing housing 110 and a turbine housing 120. The bearing housing 110 and turbine housing 120 may be integrally formed or, alternatively, may be formed separately and fixed together using, for example, screws or bolts.

The turbine housing 120 comprises an inlet 122, a volute 124 and a generally cylindrical chamber 126. Chamber 126 is suitable for receipt of a turbine wheel (not shown) and, optionally, a stator. In use, a fluid enters the turbine housing via inlet 122, flows into the volute 124, and passes through an annular passage 128 into chamber 126. If present, the stator may be disposed upstream of the turbine wheel and may comprise a plurality of guide vanes. The guide vanes may be arranged to direct the fluid flowing through the annular chamber 126 onto blades of the turbine wheel. The fluid may pass through the stator and drive the turbine wheel to rotate.

In an alternative embodiment, the fluid may through the turbine housing 120 in the opposite direction, i.e. axially inwards through chamber 126 and outwards through inlet 122. For such embodiments, the volute 124 may be replaced by a generally toroidal collector.

Bearing housing 110 is provided with a generally cylindrical bore 111 within which is received a bearing assembly 200. The bearing assembly 200 is a rolling element bearing, comprising an inner race 210, an outer race 220 and two sets of rolling elements 231, 232 disposed therebetween. Although bearing assembly 200 comprises two sets of rolling elements 231, 232 disposed between the inner and outer races 210, 220, in alternative embodiments the bearing assembly may comprise one or more than two (for example three) sets of rolling elements disposed between the inner and outer races 210. An outer radial dimension of the outer race 220 of the bearing assembly 200 substantially matches an inner radial dimension of the bore 111. Bore 111 is a counter-bore such that the bearing housing 110 is provided with an annular shoulder 112. One end of the outer race 220 of the bearing assembly 200 abuts annular shoulder 112. The bearing housing is further provided with a second bore 113, which is coaxial with bore 111 and of smaller diameter. Bore 113 opens out into chamber 126 of the turbine housing 120. In use, bearing assembly 200 supports a shaft (not shown), which extends through a bore 211 in the inner race 210. One end of the shaft to which the turbine wheel is mounted extends through bore 113 and into chamber 126. Another end of the shaft extends out of bore 111. In some embodiments housing 100 may, for example, form part of an electrical generator. In such embodiments, a rotor (for example one or more permanent magnets) of an electrical generator may be coupled to the end of the shaft that extends out of bore 111 so that rotation of the shaft causes rotation of the rotor. This may induce an electromotive force in a stator (for example a coil of copper wire) arranged around the rotor.

An anti-rotation device 300 according to an embodiment of the present disclosure cooperates with the bearing housing 110 and the bearing assembly 200 as now described. Together, the bearing housing 110, the bearing assembly 200 and the anti-rotation device 300 form a bearing unit that may be considered to be an assembly. The bearing housing 110 and the bearing assembly 200 may be considered to form first and second members of the assembly respectively. The anti-rotation device 300 rotationally locks the bearing housing 110 to the outer race 220 of the bearing assembly 200, preventing rotation of one relative to the other. Further, along with the annular shoulder 112 formed by counter-bore 111, the anti-rotation device 300 acts to axially constrain the bearing assembly 200 within bore 111.

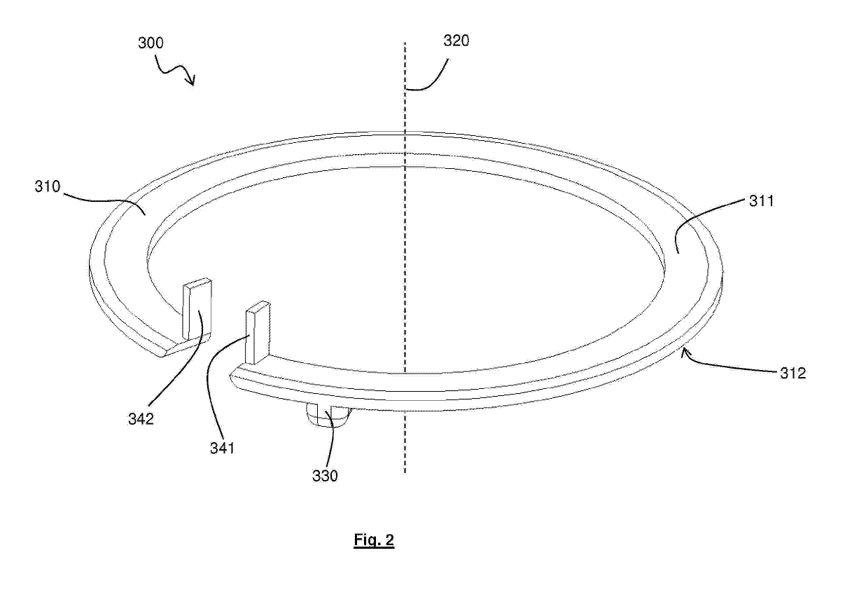

FIG. 2 shows the anti-rotation device 300, which comprises an arcuate resilient body 310. Body 310 is generally planar and lies substantially within a plane. The body is of the form of a circlip or snap ring, which curves around a central axis 320. In the following, an axial direction may refer to a direction that is substantially normal to the plane of body 310 and a radial direction may refer to a direction within said plane that passes through the central axis 320.

The body 310 comprises two opposed axially facing surfaces 311, 312, each of which is of the form of a major sector of an annulus. Therefore the body 310 is generally annular in shape but with a circumferential gap.

The anti-rotation device 300 further comprises a protrusion 330, which extends away from surface 312 in a generally axially direction. The anti-rotation device 300 is further provided with a pair of flanges 341, 342 to allow it to be distorted radially. The flanges 341, 342 form gripping features that allow a gripping tool such as, for example, a pair of pliers to grip and radially distort the anti-rotation device 300. Each flange 341, 342 extends away from surface 311 in a generally axial direction.

The flanges 341 may be formed integrally with the arcuate body 310. For example, the anti-rotation device 300 may be formed from a single flat sheet of material and the flanges 341, 342 may each be formed by bending a section of the material.

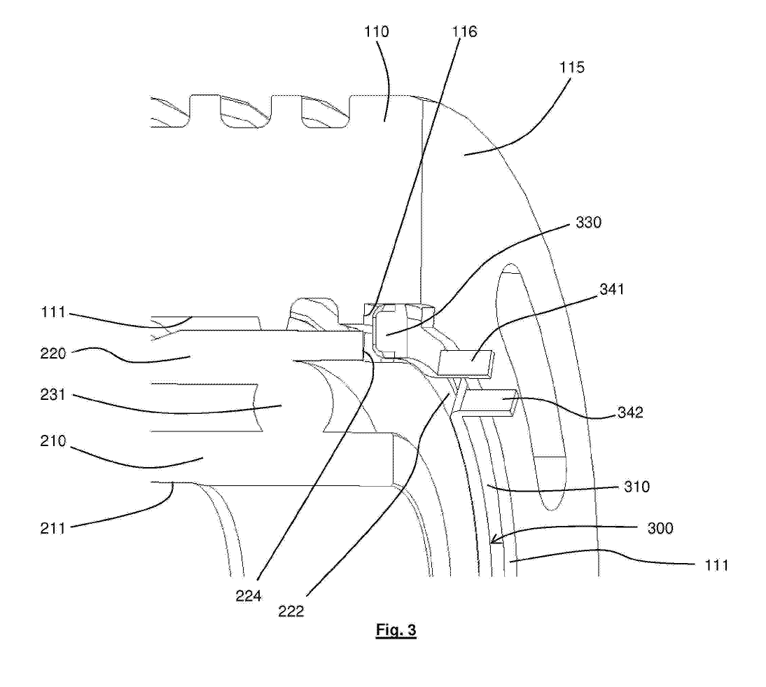

Protrusion 330 provides both: (a) a first anti-rotation feature for cooperation with a complimentary feature of the bearing housing 110; and (b) a second anti-rotation feature for receipt within a recess in a surface of the outer race 220 of bearing assembly 200 as now described with reference to FIGS. 3 to 7.

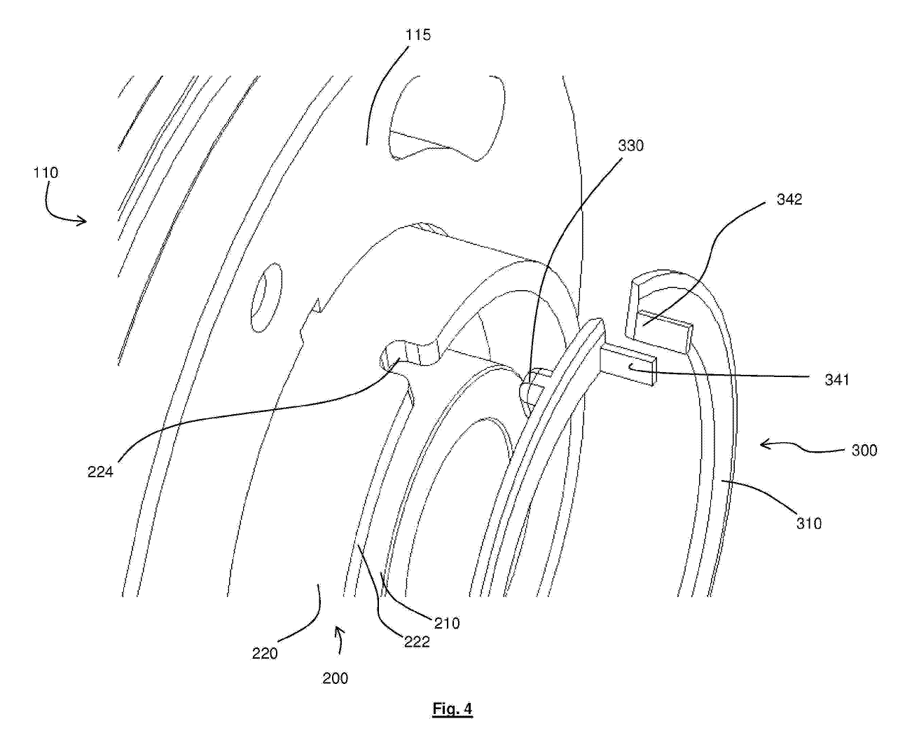

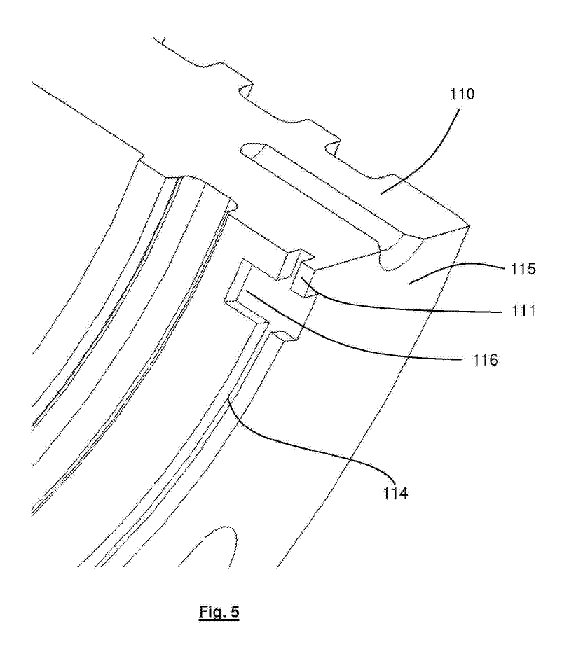

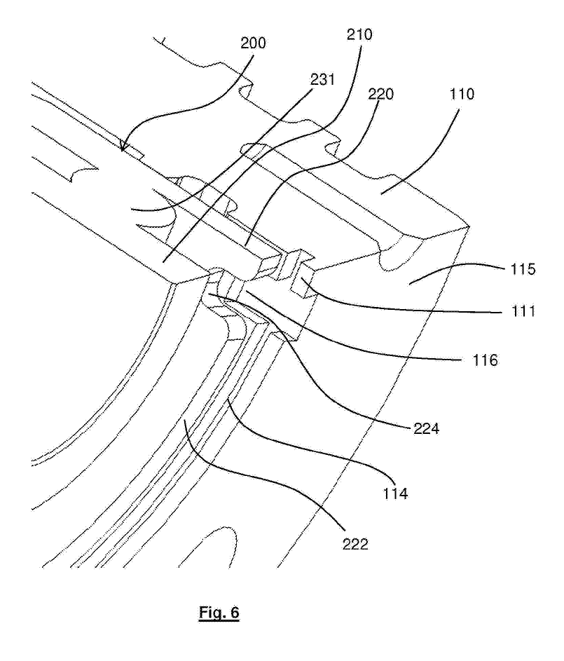

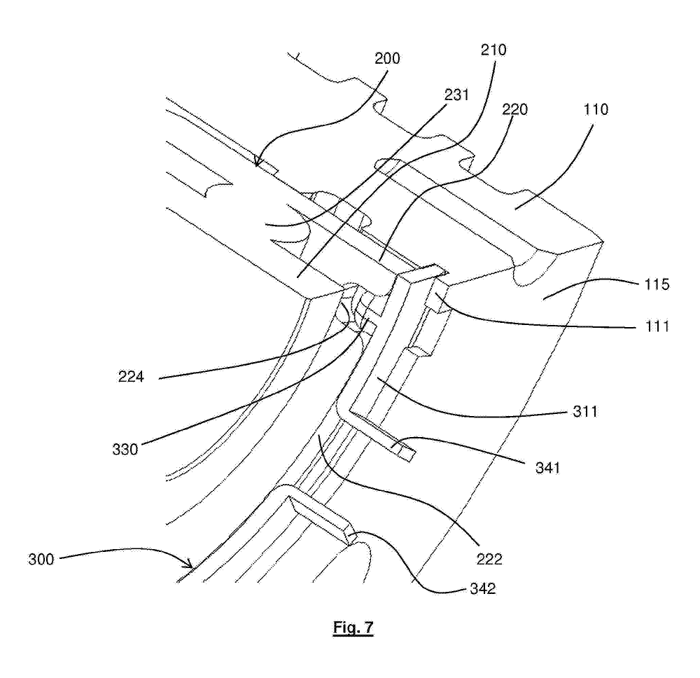

FIG. 3 is an enlarged portion of FIG. 1 and shows the anti-rotation device 300 engaged with both the bearing housing 110 and outer race 220 of the bearing assembly 200. FIG. 4 is an exploded view of the arrangement, with the bearing assembly 200 only partially inserted into bore 111 of bearing housing 110. FIG. 5 shows a partial cross sectional view of a portion of the bearing housing 110 before the bearing assembly 200 has been inserted into bore 111. FIG. 6 shows the same partial cross sectional view of a portion of the bearing housing 110 of FIG. 5 but with the bearing assembly 200 received within bore 111. FIG. 7 shows the same partial cross sectional view of a portion of the bearing housing 110 and the bearing assembly 200 shown in FIG. 6 but with the anti-rotation device 300 inserted.

As can be seen most clearly in FIGS. 5 and 6, the bearing housing 110 is further provided with an annular groove 114 on an inner surface of bore 111 proximate to an end 115 of the bearing housing 110. Further, the bearing housing 110 is further provided with a recess 116 on an inner surface of bore 111 proximate to end 115, said recess extending axially away from the annular groove 114 into bore 111. In the embodiment shown in the drawings, recess 116 also extends axially away from the annular groove 114 to an end 115 of the bearing housing 110. In some embodiments, the portion of recess 116 that lies between annular groove 114 and end 115 may be absent. However, it may be easier to machine a recess 116, for example by milling, which extends to the end 115 of the bearing housing 110.

As can be seen most clearly in FIGS. 4 and 6, a recess 224 is formed in the outer race 220 of bearing assembly. The recess 224 extends axially away from an axially facing end surface 222 of the outer race 220.

In use, a radially outer portion of the body 310 of anti-rotation device 300 is received within annular groove 116. A radially inner portion of anti-rotation device 300 abuts the end surface 222 of the outer race 220 of bearing assembly 200. In particular, a radially inner portion of axially facing surface 312 contacts an axially facing end surface 222. Protrusion 330 is received within recesses 116, 224. In particular, a radially outer portion of protrusion 330 is received within the recess 116 in the bearing housing 110 and may be considered to form a first anti-rotation feature. Further, a radially inner portion of protrusion 330 is received within the recess 224 in the outer race 220 of bearing assembly 200 and may be considered to form a second anti-rotation feature.

In order to assemble the housing 100, first the bearing assembly 200 is inserted into bore 111 of the bearing housing 110 until an end of the outer race 220 of bearing assembly 200 contacts annular shoulder 112. The outer race 220 of the bearing assembly 200 is rotated relative to the bearing housing until recesses 116, 224 are aligned (i.e. they may be disposed at substantially the same circumferential position).

Next, a compression force is applied to the arcuate resilient body 310 of the anti-rotation device 300. This may be achieved by squeezing the two flanges 341, 342 together using a pair of pliers or other suitable tool. While the anti-rotation device 300 is under compression, it is inserted into the bore 111 in the bearing housing 110. If necessary, the anti-rotation device 300 is rotated until the protrusion 330 is aligned with the two recesses 116, 224. The anti-rotation device 300 is inserted further into the bore 111 until axially facing surface 312 of the anti-rotation device 300 abuts an end face of the outer race 220 and the protrusion 330 is partially received within the recess 224 in the outer race of the bearing assembly.

Finally, the compression force is removed from the anti-rotation device 300 such that it expands so that a radially outer portion of the body 310 is received within annular groove 114; a radially outer portion of protrusion 330 is received within recess 116; and a radially inner portion of protrusion 330 is received within recess 224. A circumferential extent of protrusion 330 substantially matches that of the recesses 116, 224 thus rotationally locking the anti-rotation device 300 to both the bearing housing 110 and the outer race 220.

An axial dimension of the outer race 220 of the bearing assembly 200 substantially matches the distance between the annular shoulder 112 of the bore 111 and the annular groove 114. Therefore, when the anti-rotation device 300 is disposed in the annular groove it is constrained axially such that the distance between the annular shoulder 112 of the bore 111 and the axially facing surface 312 of the anti-rotation device 300 substantially matches an axial dimension of the outer race 220 of the bearing assembly 200. Therefore, in use, the annular shoulder 112 and the anti-rotation device 300 together act to axially constrain the bearing assembly 200 within bore 111.

Although the above describe embodiment uses a rolling element bearing assembly 200, in some embodiments other types of bearing assembly such as, for example, journal bearings may alternatively be used.

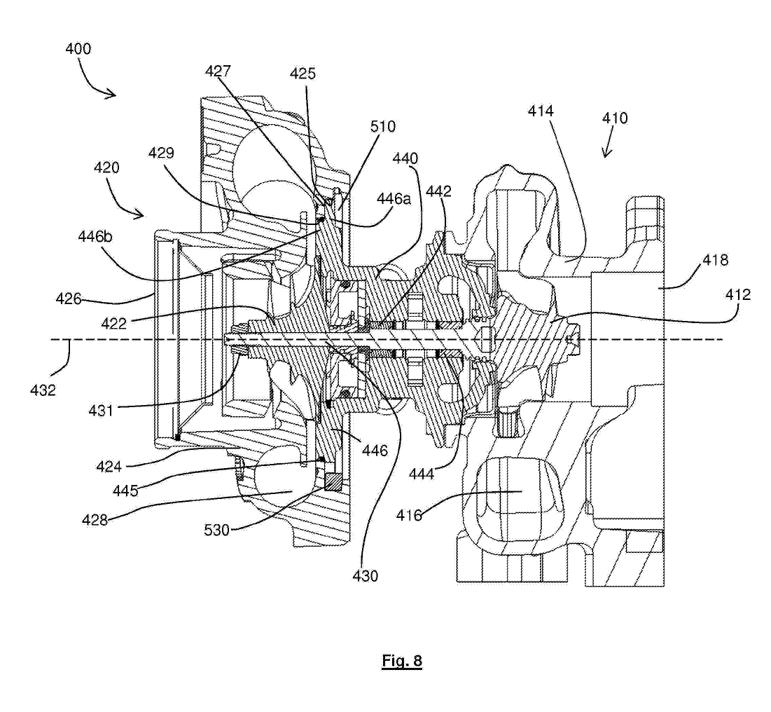

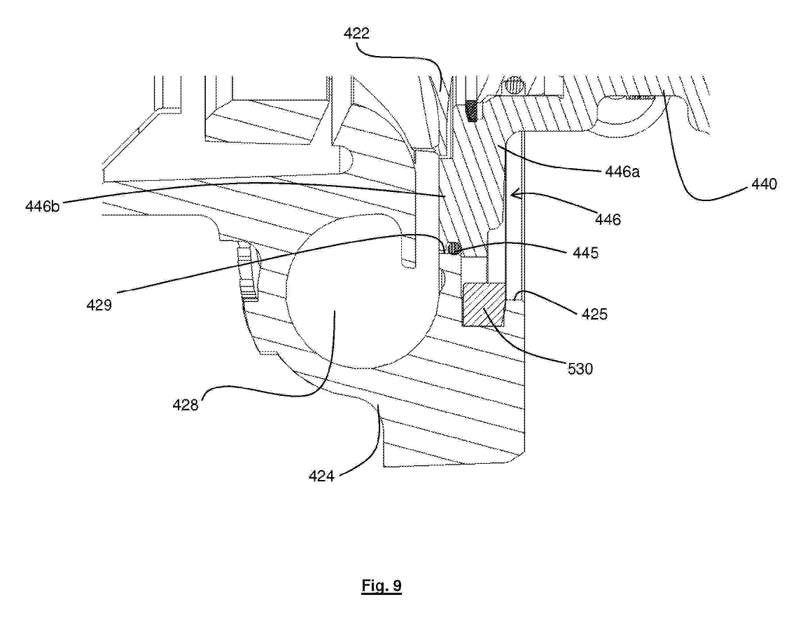

FIG. 8 is a cross sectional view of a turbocharger 400 according to an embodiment of the present disclosure. FIG. 9 is an enlarged view of a portion of the cross sectional view of a turbocharger 400 shown in FIG. 8.

The turbocharger 400 comprises a turbine 410 and a compressor 420 interconnected by a shaft 430. The turbine 410 comprises a turbine wheel 412 disposed in a turbine housing. The compressor 420 comprises a compressor wheel 422 disposed in a compressor housing.

Shaft 430 extends from the turbine 410 to the compressor 420 through a bearing housing 440 and supports at one end the turbine wheel 412 for rotation within the turbine housing and, at the other end, the compressor wheel 422 for rotation within the compressor housing. In use, the shaft 430 rotates about turbocharger axis 432 on bearing assemblies 442, 444 located in the bearing housing 440.

In the illustrated embodiment the bearing assemblies 442, 444 are journal bearings although it will be appreciates that other types of bearing assembly (such as rolling element bearing assemblies) may alternatively be used. The two bearing assemblies 442, 444 are housed towards the compressor end and turbine end of the bearing housing 440 respectively. In use, oil is fed to the bearings assemblies 442, 444 under pressure, for example from the oil system of an engine via an oil inlet and one or more passages (not shown in the cross section of FIG. 8). Each bearing assembly 442, 444 is provided with circumferentially spaced radial holes for oil to pass to the turbocharger shaft 430. The oil drains out of the bearing assemblies 442, 444 via an oil outlet (not shown in the cross section of FIG. 8) and may, for example return to an engine sump.

The turbine housing 410 defines an inlet chamber 416 (typically a volute) to which exhaust gas from an internal combustion engine is delivered. The exhaust gas flows from the inlet chamber 416 to an axially extending outlet passageway 418 via the turbine wheel 412 causing it to rotate. As a result, torque is transmitted by the shaft 430 to the compressor wheel 422. Rotation of the compressor wheel 422 within the compressor housing pressurises ambient air drawn in through an air inlet 426 and delivers the pressurised air to an air outlet volute 428 from where it is fed to an inlet manifold of the internal combustion engine. The speed of the turbine wheel 412 is dependent upon the velocity of the gas passing from the inlet chamber 416 to the outlet passageway 418 and governs the speed of rotation of the compressor wheel 422.

To aid assembly of the turbocharger 400, the compressor housing that houses the compressor wheel 422 comprises two members that cooperate to form a housing and, similarly, the turbine housing that houses the turbine wheel 412 comprises two members that cooperate to form a housing.

The compressor housing is formed by cooperation of a flange 446 formed on the central bearing housing 440 and a compressor cover 424. The flange 446 is radially outboard of a main body of the bearing housing 440. To assemble the compressor 420, the compressor wheel 422 is mounted on the shaft, which is received within a central bore in the bearing housing 440. The compressor wheel 422 is axially retained on by cooperation of a retaining nut 431 with an external thread on the shaft 430. Once the compressor wheel 422 is in place, the compressor cover 424 is brought into cooperation with the flange 446 on the bearing housing 440.

Similarly, the turbine housing is formed by cooperation of the central bearing housing 440 and a turbine cover 414. To assemble the turbine 410, the turbine wheel 412 is mounted on the shaft, which is received within a central bore in the bearing housing 440. Once the turbine wheel 412 is in place, the turbine cover 414 is brought into attached to the bearing housing 440.

The compressor cover 424 is provided with stepped bore within which the flange 446 of the bearing housing 440 is received. The stepped bore comprises generally cylindrical, co-axial first and second bores 425, 429. A diameter of the first bore 425 is larger than the diameter of the second bore 429. An annular shoulder 427 is formed between the first and second bores 425, 429.

The flange 446 is also stepped, comprising a first portion 446a and a second portion 446b. A diameter of the first portion 446a is larger diameter than the diameter of the second portion 446b. The first portion 446a of the flange 446 is received within the first bore 425 and the second portion 446b of the flange 446 extends into the second bore 429. A generally axially facing surface of the flange 446 abuts annular shoulder 427. An outer radial dimension of the first portion 446a of flange 446 substantially matches an inner radial dimension of the first bore 425 and an outer radial dimension of the second portion of flange 446 substantially matches an inner radial dimension of the second bore 429. An O-ring 445 is received in a circumferential groove on an outer surface of the second portion 446b of the flange 446 and acts to form a seal between the compressor cover 424 and the flange 446.

An anti-rotation device 500 according to an embodiment of the present disclosure cooperates with both the flange 446 on the central bearing housing 446 and a compressor cover 424. The anti-rotation device 500 serves to join the compressor cover 424 to the bearing housing 440 in such a way that the compressor cover 424 is prevented from rotating relative to the bearing housing 440, as now described.

Together, the compressor cover 424, the bearing housing 440 and the anti-rotation device 500 may be considered to form an assembly. The compressor cover 424 and the bearing housing 440 may be considered to form first and second members of the assembly respectively. The anti-rotation device 500 rotationally locks the compressor cover 424 to the bearing housing 440, preventing rotation of one relative to the other. Further, the anti-rotation device 500 acts to axially constrain the flange 446 of the bearing housing 440 within the stepped bore 425, 429 in the compressor cover.

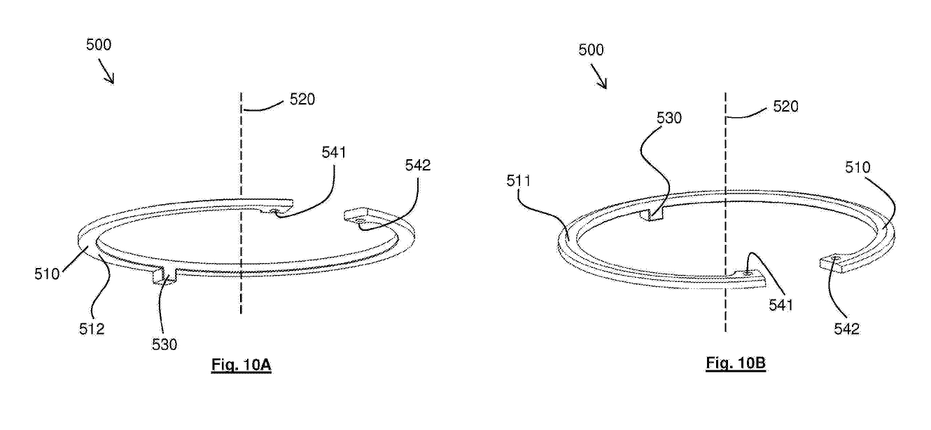

FIGS. 10A and 10B show the anti-rotation device 500, which may be substantially similar to the anti-rotation device 300 shown in FIG. 2. The anti-rotation device 500 comprises an arcuate resilient body 510. Body 510 is generally planar and lies substantially within a plane. The body is of the form of a circlip or snap ring, which curves around a central axis 520. In the following, an axial direction may refer to a direction that is substantially normal to the plane of body 510 and a radial direction may refer to a direction within said plane that passes through the central axis 520.

The body 510 comprises two opposed axially facing surfaces 511, 512, each of which is of the form of a major sector of an annulus. Therefore the body 510 is generally annular in shape but with a circumferential gap.

The anti-rotation device 500 further comprises a protrusion 530, which extends away from surface 512 in a generally axially direction. The anti-rotation device 500 is further provided with a pair of apertures 541, 542 (each adjacent to an opposite end of arcuate body 510) to allow it to be distorted radially. The apertures 541, 542 form gripping features that allow a gripping tool such as, for example, a pair of pliers to grip and radially distort the anti-rotation device 500.

In this embodiment, the protrusion 530 is provided diametrically opposite to the circumferential gap separating the two ends of arcuate body 510. However, it will be appreciated that in other embodiments the protrusion 530 may be provided at any convenient circumferential position on the arcuate body 510. The cross sectional view of the turbocharger 400 shown in FIGS. 8 and 9 is through a plane which passes through the protrusion 530 and the circumferential gap separating the two ends of arcuate body 510. Therefore, at the bottom of FIG. 8 and in FIG. 9 the protrusion 530 of the anti-rotation device 500 can be seen in cross section. Furthermore, at the top of FIG. 8 an end of the arcuate body 510 can be seen.

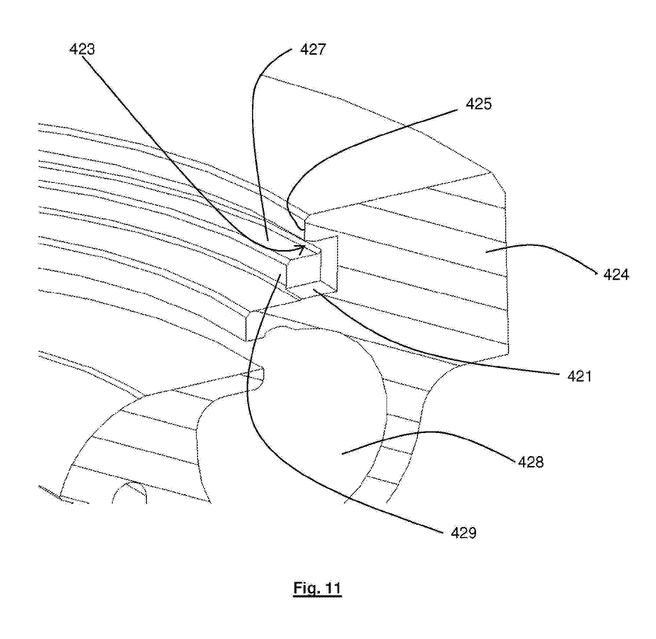

Protrusion 530 provides both: (a) a first anti-rotation feature for cooperation with a complimentary feature of the compressor cover 424; and (b) a second anti-rotation feature for receipt within a recess in a surface of the flange 446 on the bearing housing 440, as now described with reference to FIGS. 11 to 13.

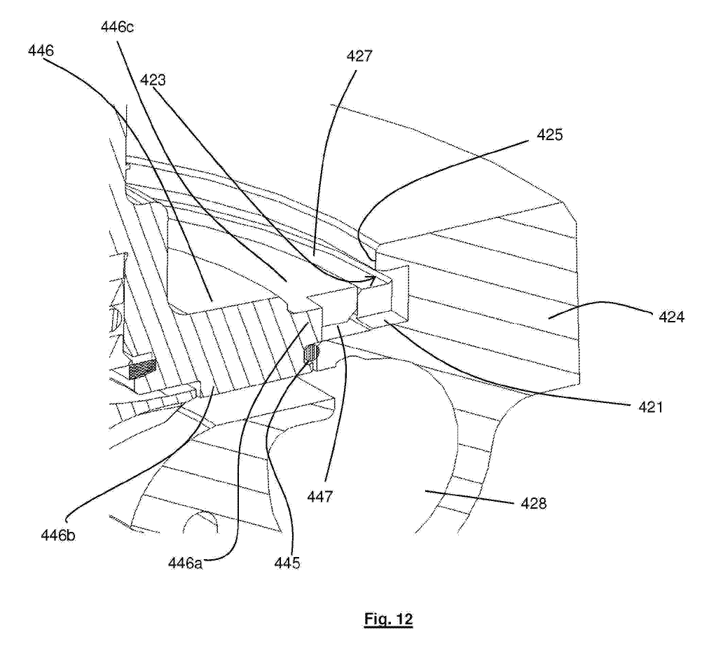

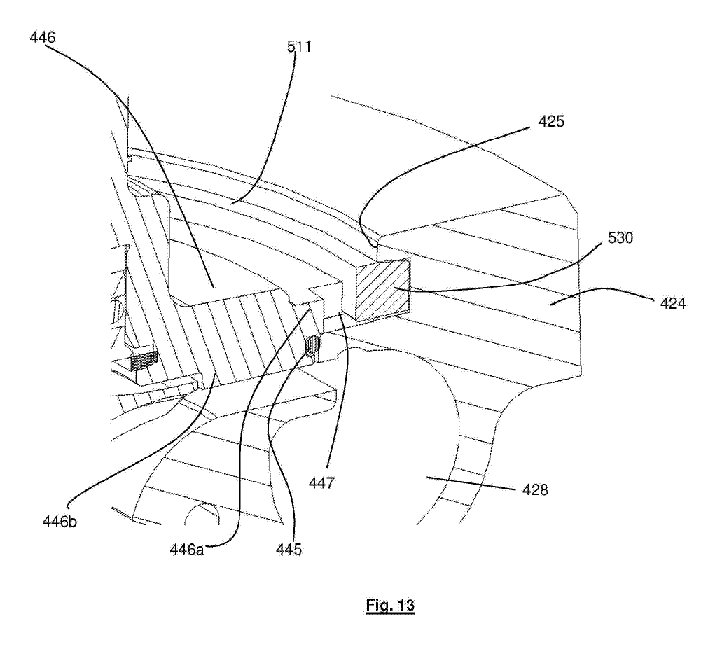

FIG. 11 shows a partial cross sectional view of a portion of the compressor cover 424 before cooperation with the bearing housing 440. FIG. 12 shows the same partial cross sectional view of a portion of the compressor cover 424 of FIG. 11 but with the flange 446 of the bearing housing 440 received within first and second bores 425, 429 (as described above). FIG. 13 shows the same partial cross sectional view of a portion of the compressor cover 224 and the bearing housing 440 shown in FIG. 12 but with the anti-rotation device 500 inserted. The cross sections in FIGS. 8, 9 and 11 to 13 are all through a common plane. Therefore, in FIG. 13 the protrusion 530 of the anti-rotation device 500 can be seen in cross section.

As can be seen most clearly in FIGS. 11 and 12, the compressor cover 424 is further provided with an annular groove 423 on an inner surface of the first bore 425. Further, the compressor cover 424 is further provided with a recess 421 on an inner surface of the first bore 425, said recess 421 extending axially away from the annular groove 114 into the first bore 425.

As can be seen most clearly in FIG. 12, a recess 447 is formed in the first portion 446a of the flange 446 of bearing housing 440. The recess 447 extends axially away from an axially facing end surface 446c of the first portion 446a of the flange 446 of bearing housing 440.

In use, a radially outer portion of the body 510 of anti-rotation device 500 is received within annular groove 423. A radially inner portion of anti-rotation device 500 abuts the end surface 446c of the flange 446 of bearing housing 440. In particular, a radially inner portion of axially facing surface 512 contacts axially facing end surface 446c. Protrusion 530 is received within recesses 421, 447. In particular, a radially outer portion of protrusion 530 is received within the recess 421 in the compressor cover 424 and may be considered to form a first anti-rotation feature. Further, a radially inner portion of protrusion 530 is received within the recess 447 in the first portion 446a of the flange 446 of bearing housing 440 and may be considered to form a second anti-rotation feature.

In order to assemble the compressor housing, first the flange 446 of the bearing housing 440 is inserted into the stepped bore 425, 429 of the compressor cover 424 until: the first portion 446a of the flange 446 is received within the first bore 425, the second portion 446b of the flange 446 extends into the second bore 429, and a generally axially facing surface of the flange 446 abuts annular shoulder 427. The bearing housing 440 is rotated relative to the compressor cover 424 until recesses 421, 447 are aligned (i.e. they are disposed at substantially the same circumferential position).

Next, a compression force is applied to the arcuate resilient body 510 of the anti-rotation device 500. This may be achieved by squeezing the two ends of the body 510 (at which are provided the two apertures 541, 542) together using a pair of pliers or other suitable tool. While the anti-rotation device 500 is under compression, it is inserted into the first bore 425 in the compressor cover 424. If necessary, the anti-rotation device 500 is rotated until the protrusion 530 is aligned with the two recesses 421, 447. The anti-rotation device 500 is inserted further into the first bore 425 until axially facing surface 512 of the anti-rotation device 500 abuts the end face 446c of the flange 446 and the protrusion 530 is partially received within the recess 447 in the first portion 446a of the flange 446.

Finally, the compression force is removed from the anti-rotation device 500 such that it expands so that a radially outer portion of the body 510 is received within annular groove 423; a radially outer portion of protrusion 530 is received within recess 421; and a radially inner portion of protrusion 530 remains within recess 447. A circumferential extent of protrusion 530 substantially matches that of the recesses 421, 447. Therefore, the anti-rotation device 500 is rotationally locked to both the compressor cover 424 and the flange 446.

An axial dimension of the body 510 of the anti-rotation device 500 substantially matches an axial dimension of the annular groove 423. Therefore, when the anti-rotation device 500 is disposed in the annular groove 423 it is constrained axially. Furthermore, an axial dimension of the first portion 446a of the flange 446 of the bearing housing 440 substantially matches the distance between the annular shoulder 427 of the stepped bore 425, 429 and the annular groove 423. Therefore, when the anti-rotation device 500 is disposed in the annular groove 423 the distance between the annular shoulder 427 of the stepped bore 425, 429 and the axially facing surface 512 of the anti-rotation device 500 substantially matches the axial dimension of the first portion 446a of the flange 446 of the bearing housing 440. Therefore, in use, the annular shoulder 427 and the anti-rotation device 500 together act to axially constrain the flange 446 of the bearing housing 440 within stepped bore 425, 429.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below.

One or more features of any of the above described embodiments may be combined with one or more features of any other of the above described embodiments.

It will be appreciated that embodiments of the present disclosure concern an assembly comprising a first member, a second member and an anti-rotation device. In one specific embodiment described above (with reference to FIGS. 1 to 7), the assembly is a bearing unit, the first member is a bearing housing and the second member is a bearing assembly. In another specific embodiment described above (with reference to FIGS. 8 to 13), the assembly is a compressor housing, the first member is a compressor cover and the second member is a bearing housing. It will be appreciated, however, that the present disclosure is not limited to these two embodiments and that the first and second members may be different components. For example, in an alternative embodiment, the assembly is a turbine housing, the first member is a turbine cover and the second member is a bearing housing.

While the invention has been illustrated and described in detail in the drawings and foregoing description, the same is to be considered as illustrative and not restrictive in character, it being understood that only the preferred embodiments have been shown and described and that all changes and modifications that come within the scope of the inventions as defined in the claims are desired to be protected. In reading the claims, it is intended that when words such as “a” or “an” are used there is no intention to limit the claim to only one item unless specifically stated to the contrary in the claim. When the language “at least a portion” and/or “a portion” is used the item can include a portion and/or the entire item unless specifically stated to the contrary. For the avoidance of doubt, optional and/or preferred features as set out herein may be used either individually or in combination with each other where appropriate and particularly in the combinations as set out in the accompanying claims. The optional and/or preferred features for each aspect of the invention set out herein are also applicable to any other aspects of the invention, where appropriate.

What is claimed is:

1. An assembly comprising:
a first member provided with a bore and a groove on a surface of the bore;
a second member, at least a portion of the second member being disposed within the bore in the first member, a recess being provided on a generally axially facing surface of said portion of the second member; and
an anti-rotation device comprising:
an arcuate resilient body comprising a radially inner portion and a radially outer portion, the radially outer portion being received within the groove, the radially inner portion abutting a surface of said portion of the second member;
a first anti-rotation feature provided on the radially outer portion for cooperation with a complimentary feature of the first member; and
a second anti-rotation feature provided on the radially inner portion extending away from the radially inner portion of the body in a generally axial direction and being received within the recess on the second member.

2. The assembly of claim 1, wherein the first anti-rotation feature comprises a protrusion.

3. The assembly of claim 2, wherein the protrusion extends axially outwards from the radially outer portion.

4. The assembly of claim 1, wherein the first and second anti-rotation features form two different parts of a single protrusion from the arcuate body.

5. The assembly of claim 1, wherein the first and second anti-rotation features are disposed at substantially the same position along the arcuate body.

6. The assembly of claim 1, wherein the first and second anti-rotation features are each disposed at a position along the arcuate body that is proximate to one end of the arcuate body.

7. The assembly of claim 1, wherein the arcuate resilient body is generally planar and lies substantially within a plane.

8. The assembly of claim 1, wherein when not under tension, the body is generally of the form of a major sector of an annulus.

9. The assembly of claim 1, wherein the arcuate resilient body is provided with a generally axially facing surface, a radially inner portion of said surface being complimentary to a generally axially facing surface of the portion of the second member.

10. The assembly of claim 1, further comprising one or more gripping features provided on the arcuate body to aid griping of the body so that a compression force may be applied to it.

11. The assembly of claim 10, wherein the axially extending second anti-rotation feature and one of the gripping features are formed together.

12. The assembly of claim 1, wherein the groove is only open on one generally radially facing side.

13. The assembly of claim 1, wherein the bore in the first member comprises an annular shoulder formed between a larger diameter section and a smaller diameter section.

14. The assembly of claim 1, wherein the first member is a bearing housing and the second member is a bearing assembly.

15. The assembly of claim 14, wherein the bearing assembly is a rolling element bearing assembly comprising: an inner race, an outer race and a plurality of rolling elements disposed therebetween.

16. The assembly of claim 15, wherein the recess on the generally axially facing surface of the bearing assembly is provided on the outer race.

17. The assembly of claim 1 wherein the first member is a compressor cover and the second member is a bearing housing.

18. An anti-rotation device for use in the assembly of any claim 1.

19. (canceled)

20. (canceled)

21. (canceled)

22. A method of assembling an assembly, the method comprising:
providing a first member with a bore and a groove on a surface of the bore;
providing a second member, a recess being provided on a generally axially facing surface of the second member;
inserting at least a portion of the second member into the bore of the first member;
providing an anti-rotation device comprising: an arcuate resilient body, a first anti-rotation feature provided on a radially outer portion of the body, and a second anti-rotation feature provided on a radially inner portion of the body;
applying a compression force to the arcuate resilient body of the anti-rotation device;
inserting the anti-rotation device into the bore;
rotating the anti-rotation device relative to the first member and/or the second member until the first anti-rotation feature is aligned with a complimentary feature of the first member and the second anti-rotation feature is aligned with the recess on the generally axially facing surface of the second member;
further inserting the anti-rotation device into the bore until a surface of the anti-rotation device contacts a surface of the second member; and
removing the compression force from the anti-rotation device such that it expands so that the radially outer portion of the arcuate resilient body is received within the groove in the bore of the first member;
wherein once the assembly is assembled the first anti-rotation feature cooperates with a complimentary feature of the first member, and the second anti-rotation feature is received within the recess on the second member.
